(19) United States
(12) Patent Application Publication
(10) Pub. No.: US 2007/0201032 A1
(43) Pub. Date: Aug. 30, 2007

(54) Apparatus for inspecting a ball-bumped wafer

(75) Inventor: Hideo Ishimori, Nakai (JP)

Correspondence Address: MCDERMOTT WILL & EMERY LLP, 600 13TH STREET, N.W., WASHINGTON, DC, 20005-3096, US

(73) Assignee: HITACHI HIGH-TECHNOLOGIES CORPORATION

(21) Appl. No.: 11/709,767

(22) Filed: Feb. 23, 2007

(30) Foreign Application Priority Data
Feb. 24, 2006 (JP) 2006-048139

(51) Int. Cl. G01B 9/02; G01B 11/02

(52) U.S. Cl. 356/485; 356/503

(57) ABSTRACT

An apparatus for inspecting a ball-bumped wafer is provided in which an wafer to be inspected, in which a plurality of chips having ball bumps are formed, is mounted on a wafer table; an inspection light is irradiated from a light projection optical system to the wafer mounted on the wafer table; an intensity of the reflected light from a surface, including a bump surface, of the wafer is detected by a detection optical system; and a shape, such as a height, a diameter and a position, of the ball bump is measured on the basis of the intensity of the inspection light.

### TECHNICAL FIELD

The present invention relates to a method and an apparatus for inspecting a ball bump on a surface of a semiconductor wafer, and particularly to a method and an apparatus for inspecting a wafer or a semiconductor chip having a large amount of ball bumps.

### BACKGROUND OF THE INVENTION

A lot of bumps are formed on a surface of an IC chip formed on a semiconductor wafer, for connection to a wiring of an IC package or the like. The apparatus for inspecting the ball-bumped wafer inspects an appearance of the bump, such as a height, a diameter or a position, on whether it has a defect or not.

When the apparatus for inspecting the ball-bumped wafer measures a height of the ball, a measurement point by a height gauge is positioned at a top of the ball. Although a position of the ball is previously registered, there is a displacement between each of the chips or the balls. Thus, means for correcting the measurement position is required.

Generally, there is employed a method of finding a ball position by a camera image or the like and positioning the measurement point of the height at that position.

### SUMMARY OF THE INVENTION

Since measuring means for determining the ball position and those for measuring the ball height are independently used in the prior art, it is necessary to switch the measurement systems on each measurement of the ball height, so that it takes a lot of time to measure the heights of all of balls whose number is as high as several hundreds of thousand.

The semiconductor chip is promoted in a compact structure with multi-functions, and the ball is downsized. Thus, the number of balls is increased. Therefore, it is strongly desired to inspect the shapes of all the balls in the wafer or chip for securing reliability.

An object of the present invention is to provide an apparatus for inspecting a ball-bumped wafer, which efficiently inspects heights (including shapes) of all the ball bumps in a process for producing the ball-bumped wafer.

According to the invention, there is provided an apparatus for inspecting a ball bump on a surface of a semiconductor wafer, wherein the apparatus acquires an image data and a height data of the same position of the ball bump at the same timing.

In particular, there is provided an apparatus for inspecting a ball-bumped wafer according to the invention, in which an wafer to be inspected, in which a plurality of chips having ball bumps are formed, is mounted on a wafer table; an inspection light is irradiated from a light projection optical system to the wafer mounted on the wafer table; an intensity of the light reflected from a surface of the wafer, including a bump surface, is detected by a detection optical system; and a shape, such as a height, a diameter and a position, of the ball bump is determined on the basis of the intensity of the inspection light.

According to an embodiment of the invention, the apparatus for inspecting the ball-bumped wafer is configured such that an optical system obtaining a brightness (that is, a chip image) from a reflected light and an optical system measuring a height are incorporated coaxially (that is, they use the same objective lens), and thus the image data and the height data of the same position can be obtained at the same timing.

In inspecting the wafer with ball bumps, the apparatus according to the invention acquires the image data and the height data at the same position and at the same timing, determines a position of a top point of the ball with the image data, and extracts the height data corresponding to the determined position. Thus, it is possible to measure the ball shape such as the height, the diameter and the position, in a short time without switching the image and the height measurement systems.

Furthermore, it is possible to simultaneously execute a visual inspection of the measured chip on the basis of the simultaneously obtained image data.

According to the invention, one scanning makes it possible to execute the inspection of the shape, such as the height, the diameter and the position, of the ball on the wafer and the visual inspection of the measured chip, and thus it is possible to efficiently inspect the ball-bumped wafer.

Other objects, features and advantages of the invention will become apparent from the following description of the embodiments of the invention taken in conjunction with the accompanying drawings.

### BRIEF DESCRIPTION OF DRAWINGS

FIG. 1 is a view showing a schematic arrangement of an apparatus for inspecting a ball-bumped wafer according to an embodiment of the invention;

FIG. 2 is a view showing a sampling position of an image data and a height data, according to the embodiment of the invention;

FIG. 3A shows an example of a monitor image of a bump obtained by the apparatus of the invention;

FIG. 3B shows an image data (brightness data) of the bump image of FIG. 3A;

FIG. 3C shows height data of the bump image of FIG. 3A; and

FIG. 3D shows a determination of a ball profile on the basis of the image data of FIG. 3B.

### DETAILED DESCRIPTION OF THE INVENTION

A description will be given below of an embodiment of the invention with reference to the accompanying drawings.

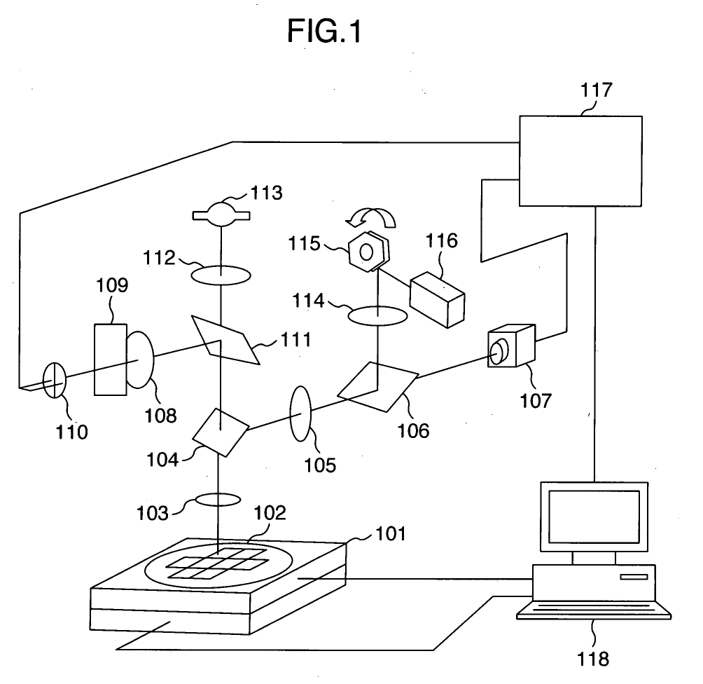

FIG. 1 is a view showing a schematic arrangement of an apparatus for inspecting a ball-bumped wafer according to an embodiment of the invention.

The apparatus for inspecting the ball bump in the embodiment is configured to include an X-Y stage 101 (an inspection stage), an objective lens 103 and the like (an inspection optical system), a signal processor 117 and a control device 118 controlling the inspecting apparatus.

An illumination light is irradiated from a lamp 113 and passes through a collimate lens 112, a third half mirror 111, a first half mirror 104 and the objective lens 103 to a wafer 102 to be inspected.

A light reflected from the inspected wafer 102 is reflected by the first half mirror 104, then passes through an image formation lens 105 for measuring an image and a second half mirror 106, and is detected by an image camera 107.

These are referred to as “an image measurement system”.

A laser light 116 for measuring a height is made an X-directional scanning beam through a polygon scanner 115 and an F-θ lens 114. It passes through the second half mirror 106 and the image formation lens 105 and is reflected by the first half mirror 104. Then it goes through the objective lens 103, and is irradiated onto the wafer 102. Thus, the height measuring beam becomes an X-directional scanning beam on the wafer 102.

The laser light reflected from the wafer 102 passes through the objective lens 103 and the first half mirror 104. It is reflected by the third half mirror 111, and passes into a two-split sensor 110 through an image formation lens 108 for measuring the height.

Since one half of the light passed the image formation lens for measuring the height is blocked by a knife edge 109, the detected light by the two-split sensor reflected from the wafer 102 changes in light income between right and left according to a position in a Z (height) direction of the wafer 102, whereby it is possible to measure the height of the wafer or the ball bump. These are referred to as “a height measurement system”.

The objective lens 103 serves concurrently to both optical systems of the height measurement system and the image measurement system. In other words, the objective lens 103 serves concurrently to both optical systems for guiding the reflected lights of the image data and the height data reflected from the wafer, and is positioned on the same axis of both of the optical systems.

Accordingly, since an image (a two-dimensional image, which is referred to as “2-D image” below) of the wafer surface (including the ball bump) by the image camera 107 and the height data by the two-split sensor 110 are measured through the same objective lens 103 as stated above, it is possible to measure the same position of the inspected wafer at the same timing.

The wafer to be inspected is moved by the X-Y stage 101 so as to be executed a full-surface inspection.

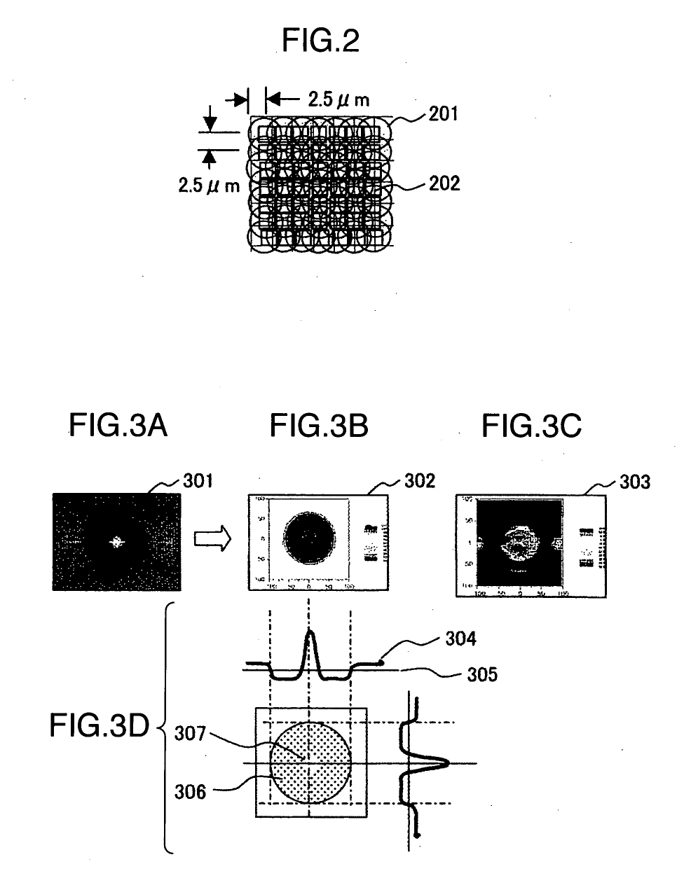

FIG. 2 is a view explaining sampling positions of the height data and the image data.

Height sampling positions 201 (indicated by circles in the drawing) and image sampling positions 202 (indicated by squares in the drawing) are respectively overlapped at a pitch of 2.5 μm. The sampling timing thereof is the same.

At a time of inspecting the wafer 102 to be measured, the image data and the height data of the entire surface of the wafer are measured at the pitch of 2.5 μm and a result of inspection of the bump shape, such as the height, the diameter and the position, is obtained.

A visual inspection of the wafer surface is simultaneously executed.

However, the sampling pitch is not limited to 2.5 μm.

FIGS. 3A to 3D are views showing a procedure of measuring a ball height.

A plurality of ball bumps such as a monitor image 301 are formed on the inspected wafer 102.

An image data 302 which is obtained by the image camera in FIG. 1 expresses a change of brightness. A height data 303 which is a result of measurement by the two-split sensor 110 in FIG. 1 is measured at the same position and at the same timing as the image data 302. Corresponding points between the image data 302 and the height data 303 have the same position and the same height.

A cross section of the brightness 304 of the image data 302 is compared with a binarization level 305 so as to determine a ball profile 306.

A ball center position 307 (a top point of the ball) is derived from the ball profile 306, and the height data corresponding to this position is selected to obtain a measurement value of the ball height which is the object of this measurement.

As stated above, according to the embodiment, it is possible to execute the measurement of the ball bump shape (the height, the diameter and the position) and the visual inspection of the wafer (the chip), through one full-surface scanning of the wafer, by measuring the image data and the displacement data at the same position and at the same timing. Accordingly, it is possible to achieve an efficient ball bump inspection.

It should be further understood by those skilled in the art that although the foregoing description has been made on embodiments of the invention, the invention is not limited thereto and various changes and modifications may be made without departing from the spirit of the invention and the scope of the appended claims.

1. An apparatus for inspecting a ball bump on a surface of a semiconductor wafer, wherein the apparatus acquires an image data and a height data of the same position of the ball bump at the same timing.

2. The apparatus according to claim 1, wherein the image data is acquired by an image camera photographing a 2D image.

3. The apparatus according to claim 1, wherein the height data is acquired by a two-split sensor.

4. The apparatus according to claim 1, wherein a height measurement of the ball bump and a visual inspection of the wafer or a chip are simultaneously executed on the basis of the image data.

5. The apparatus according to claim 1, wherein the apparatus comprises a signal processor processing the image data and the height data, and a control device controlling a whole of the inspection apparatus.

6. The apparatus according to claim 1, wherein both optical systems guiding reflected lights of the image data and the height data reflected from the wafer are positioned coaxially.
